(19) United States
(12) Patent Application Publication
(10) Pub. No.: US 2018/0291705 A1
(43) Pub. Date: Oct. 11, 2018

(54) SUBSEA ACTUATOR WITH MAGNETIC RETURN

(71) Applicant: CHEVRON U.S.A. INC., San Ramon, CA (US)

(72) Inventor: Paulo Cezar Silva PAULO, Katy, TX (US)

(73) Assignee: CHEVRON U.S.A. INC., San Ramon, CA (US)

(21) Appl. No.: 15/827,900

(22) Filed: Nov. 30, 2017

Related U.S. Application Data
(60) Provisional application No. 62/481,878, filed on Apr. 5, 2017.

(51) Int. Cl. E21B 34/06; F16K 31/06

(52) U.S. Cl. CPC E21B 34/066; F16K 31/0644

(57) ABSTRACT

The present invention is directed to a subsea actuator with magnetic return. The subsea actuator with magnetic return is assembled to a subsea valve. The subsea actuator with magnetic return allows subsea actuators to be designed with increased reliability and a reduction in size. The reduction in size also provides opportunities to reduce the size of the topsides hardware that supports the subsea valve function.

### CROSS-REFERENCE TO RELATED APPLICATION

The present application claims the benefit of U.S. Provisional application Ser. No. 62/481,878 filed on Apr. 5, 2017, entitled “Subsea Actuator With Magnetic Return”, the contents of which are incorporated herein by reference in its entirety.

### FIELD OF THE INVENTION

This invention related to a subsea actuator. In particular, this invention relates to a subsea actuator with a magnetic return.

### BACKGROUND OF THE INVENTION

Subsea valves are used in a variety of subsea applications in the oil and gas industry at a variety of depths. For example, subsea valves are used as under water safety valves in subsea trees and safety valves in production risers, or as a flow control device in manifolds, flowline connection frames and pipeline structures.

Currently subsea valves are typically equipped with an actuator that moves the valve stem in one direction via a means of motion such as a hydraulic piston. The linear motion of the hydraulic piston compresses a spring (also known as a mechanical spring) which remotely returns the valve stem to its initial position once the hydraulic pressure is released. This actuator design requires a spring that has the extended pre-set position with a force high enough to overcome 100 psi above seabed hydrostatic pressure acting over the stem area and the piston differential plus the hydraulic frictions along the system. As the industry moves towards deeper waters, the higher sea bottom hydrostatic head requires the use of longer and bulkily wired springs which can be unfeasible to be produced for some high pressure large bore valves. As a result of the longer springs, the actuators are more sensitive to its geometrical instabilities and have become more complex, heavier, and excessively large, driving subsea equipment to become exponentially larger. With larger subsea equipment higher capacity installation vessels are required and are oftentimes not available in the market.

To minimize the effects described above and compact the size of the actuators, the industry has tried many solutions, such as using a set of multiple springs, Belleville spring washers, and higher yield strength materials. These solutions have not been successful and have resulted in cracked springs, stem buckling, stem seal leakage, and seal extrusion. The reliability problems introduced by these solutions exceed the benefit obtained by the reduction in actuator size.

To address the needs of the oil and gas industry in deeper water, it would be desirable to provide a subsea actuator that is reliable and not complex, heavy, and excessively large.

### SUMMARY OF THE INVENTION

According to one embodiment, a subsea actuator with magnetic return is disclosed. In one embodiment, the subsea actuator with magnetic return is assembled to a subsea valve. The subsea actuator with magnetic return allows subsea actuators to be designed with increased reliability and a reduction in size. The reduction in size also provides opportunities to reduce the size of the topsides hardware that supports the subsea valve function.

According to one embodiment, a subsea actuator with magnetic return comprises a hydraulic actuator piston and a magnetic spring. A magnetic spring is different from a mechanical spring. The subsea actuator with magnetic return is powered by hydraulic force applied over the piston to move the valve stem in one linear direction, e.g., to open the subsea valve. Upon release of the hydraulic pressure of the piston, the subsea actuator with magnetic return is moved to the opposite direction via a magnetic spring. The magnetic spring contains an array of magnets configured to create the required magnetic density and force to move the stem of the subsea valve back to its initial position. The array of magnets is an arrangement of permanent magnets.

According to a second embodiment, a subsea actuator with magnetic return comprises the first embodiment but having a magnetic motor in lieu of the hydraulic piston, powered by an electric source. The subsea actuator with magnetic return is driven by the magnetic motor to move the valve stem in one linear direction, e.g., to open the subsea valve. Once the magnetic motor is turned off, the subsea actuator with magnetic return is moved to the opposite direction via a magnetic spring. The magnetic spring contains an array of magnets configured to create the required magnetic density and force to move the stem back to its initial position. The array of magnets is an arrangement of permanent magnets. The absence of any hydraulic actuator piston in this embodiment reduces the effects from hydrostatic head over the system motion, which in turn requires less spring force resulting in a smaller subsea actuator size.

According to a third embodiment, a subsea actuator with magnetic return comprises the second embodiment with a magnetic spring whose magnetic field can be turned on and off, or shield and unshield the magnetic force. The magnetic field of the magnetic spring can be turned off when the magnetic motor is turned on to move the valve stem in one linear direction, e.g., to open the subsea valve, so that no resistance from the magnetic spring occurs while the magnetic spring is compressed or extended. The magnetic field of the magnetic spring can be turned on when the magnetic motor is turned off to move the valve stem back to its initial position. In this embodiment, the magnetic spring is located on an actuator assembly where an electric current can be turned on and off, or shield and unshield the magnetic field. The ability to turn on and off the magnetic field of the magnetic spring will allow the reduction of the motor size. The magnetic spring can also be configured to autonomously return to its initial position via an uninterrupted power supply, e.g., a battery bank.

According to a fourth embodiment, a subsea actuator with magnetic return comprises a single magnetic spring powered by an electric source wherein variations of the current flow direction can make the single magnetic spring move in both directions. The subsea actuator with magnetic return is driven by the single magnetic spring which electric current applied in forward direction creates a magnetic field to move the stem in a linear stroke, e.g., to open the subsea valve. Once the electric current flow is applied to the single magnetic spring in the reversed direction, the single magnetic spring creates a magnetic field that moves the stem to the opposite side, e.g., to close the subsea valve. The adoption of a single bidirectional magnetic spring reduces the complexity of the subsea actuator resulting in a smaller subsea actuator design. The single magnetic spring can also be configured to autonomously return to its initial position via an uninterrupted power supply, e.g., a battery bank.

According to a fifth embodiment, a subsea actuator with magnetic return comprises the same described at first embodiment with a spring whose magnetic field can be turned on and off, or shield and unshield the magnetic force. The magnetic field can be turned off when the hydraulic pressure is applied on the piston to move the subsea actuator with magnetic return, so that no resistance from the spring occurs while the magnetic spring is compressed or extended. The magnetic field can be turned on when the hydraulic pressure is released to move the stem of the subsea valve back to its initial position. In this embodiment, the magnetic spring is located on an actuator assembly where an electric current can be turned on and off, or shield and unshield the magnetic field. The ability to turn the magnetic field on and off will allow the actuator piston area to be reduced. This reduction of the piston area in turn will require less spring force to overcome the hydrostatic head resulting in a small actuator size. The magnetic spring can also be configured to autonomously return to its initial position via an uninterrupted power supply, e.g., a battery bank.

### BRIEF DESCRIPTION OF THE DRAWINGS

The description is presented with reference to the accompanying figures in which:

FIG. 1A illustrates an embodiment of a subsea actuator with magnetic return comprising a hydraulic actuator piston and a magnetic spring. In FIG. 1A, the subsea actuator with magnetic return is in the initial position (valve closed).

FIG. 1B illustrates an embodiment of a subsea actuator with magnetic return comprising a hydraulic actuator piston and a magnetic spring. In FIG. 1B, the subsea actuator with magnetic return is in the stroked position (valve open).

FIG. 2A illustrates an embodiment of a subsea actuator with magnetic return comprising a magnetic motor powered by an electric source and a magnetic spring. In FIG. 2A, the subsea actuator with magnetic return is in the initial position (magnetic motor off and valve closed).

FIG. 2B illustrates an embodiment of a subsea actuator with magnetic return comprising a magnetic motor powered by an electric source and a magnetic spring. In FIG. 2B, the subsea actuator with magnetic return is in the stroked position (magnetic motor on and valve open).

FIG. 3A illustrates an embodiment of a subsea actuator with magnetic return comprising a magnetic motor powered by an electric source and a magnetic spring whose magnetic field can be turned on and off, or shield and unshield the magnetic force. In FIG. 3A, the subsea actuator with magnetic return is in the initial position (magnetic motor off, magnetic spring on, and valve closed).

FIG. 3B illustrates an embodiment of a subsea actuator with magnetic return comprising a magnetic motor powered by an electric source and a magnetic spring whose magnetic field can be turned on and off, or shield and unshield the magnetic force. In FIG. 3B, the subsea actuator with magnetic return is in the stroked position (magnetic motor on, magnetic spring off, and valve open).

FIG. 4A illustrates an embodiment of a subsea actuator with magnetic return comprising a single magnetic spring powered by an electric source whose variations of current flow direction can make the magnetic spring move to both directions. In FIG. 4A, the subsea actuator with magnetic return is in the initial position where the current flow is applied in the reversed direction (valve closed).

FIG. 4B illustrates an embodiment of a subsea actuator with magnetic return comprising a single magnetic spring powered by an electric source whose variations of current flow direction can make the magnetic spring move to both directions. In FIG. 4B, the subsea actuator with magnetic return is in the stroked position where the current flow is applied in the forward direction (valve open).

FIG. 5A illustrates an embodiment of a subsea actuator with magnetic return comprising a hydraulic actuator piston and a magnetic spring wherein the magnetic field can be turned on and off. In FIG. 5A, the subsea actuator with magnetic return is in the initial position (magnetic array of magnetic spring on and valve closed).

FIG. 5B illustrates an embodiment of a subsea actuator with magnetic return comprising a hydraulic actuator piston and a magnetic spring wherein the magnetic field can be turned on and off. In FIG. 5B, the subsea actuator with magnetic return is in the stroked position (magnetic array of the magnetic spring is off and valve open).

### DETAILED DESCRIPTION OF THE INVENTION

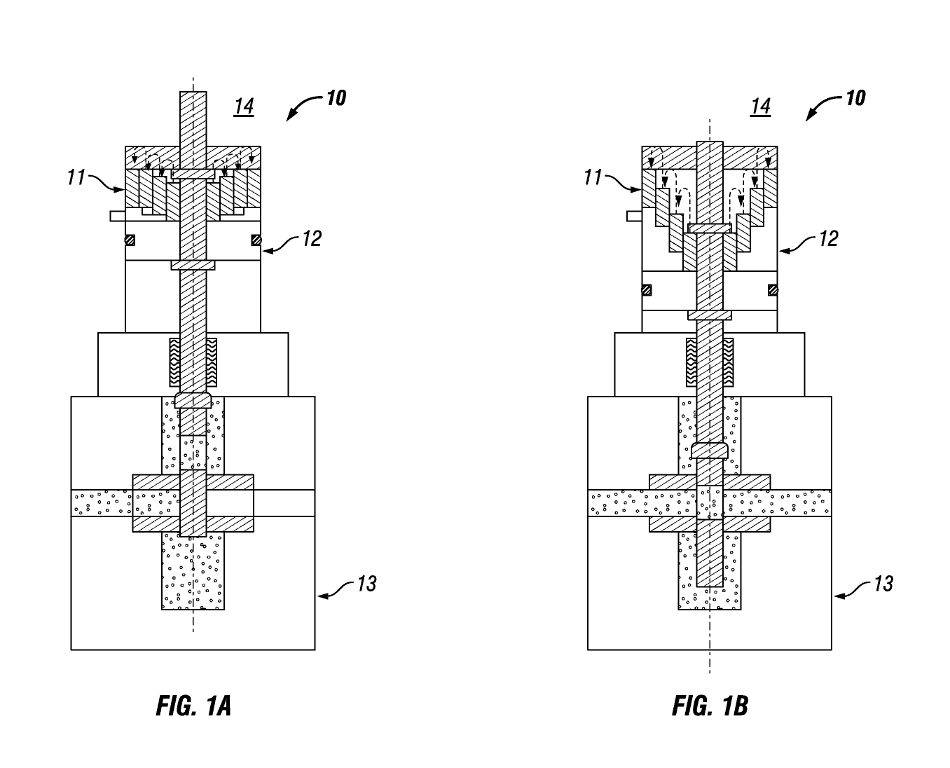

FIG. 1A illustrates an embodiment of a subsea actuator with magnetic return 10 comprising a hydraulic actuator piston 12 and a magnetic spring 11. In FIG. 1A, the subsea actuator with magnetic return 10 is in the initial position (valve closed). FIG. 1B illustrates an embodiment of a subsea actuator with magnetic return 10 comprising a hydraulic actuator piston 12 and a magnetic spring 11. In FIG. 1B, the subsea actuator with magnetic return is in the stroked position (valve open). The subsea actuator with magnetic return 10 can be assembled to a subsea valve 13. The subsea actuator with magnetic return 10 is powered by hydraulic force to move the valve stem 14 in one direction, e.g., to open the subsea valve as shown in FIG. 1B. The subsea actuator with magnetic return 10 is moved in the opposite direction via a magnetic spring 11 as shown in FIG. 1A. The magnetic spring 11 contains an array of magnets configured to create the required magnetic density and force to move the valve stem 14 back to its initial position as shown in FIG. 1A. The array of magnets is an arrangement of permanent magnets. A magnetic spring is known in the art. For example, U.S. Pat. No. 5,017,819 discloses a linear magnetic spring and a particular application for spring/motor combinations in the Stirling cycle refrigerating machine, which is especially useful in satellites to cool infrared sensors.

By using a magnetic spring in the subsea actuator with magnetic return, the dimension of the subsea actuator with magnetic return could be reduced. For example, the dimension of the subsea actuator with magnetic return could be reduced to a length that is twice the valve bore size. For example, a subsea actuator with magnetic return for a 5″ 15 ksi valve with a length of 4′ could be reduced to about 1′ long.

By using a magnetic spring in the subsea actuator with magnetic return, no mechanical contact will be required between moving and stationary elements. The lack of contact should increase the mechanical advantage and reliability of the subsea actuator. Reliability is especially critical for valves under high frequency of operation such as recirculation valves for subsea boosting systems. Reliability should also increase with the use of the magnetic spring due to the fact that magnetic springs do not suffer from metal fatigue or contact wear.

Finally, by using a magnetic spring in the subsea actuator with magnetic return, the magnetic field can be axisymmetrically homogeneous providing perfect concentricity and geometric stability along the axis of movement. This stability will eliminate risk factors from side loads which are known causes of failure for valves and actuators.

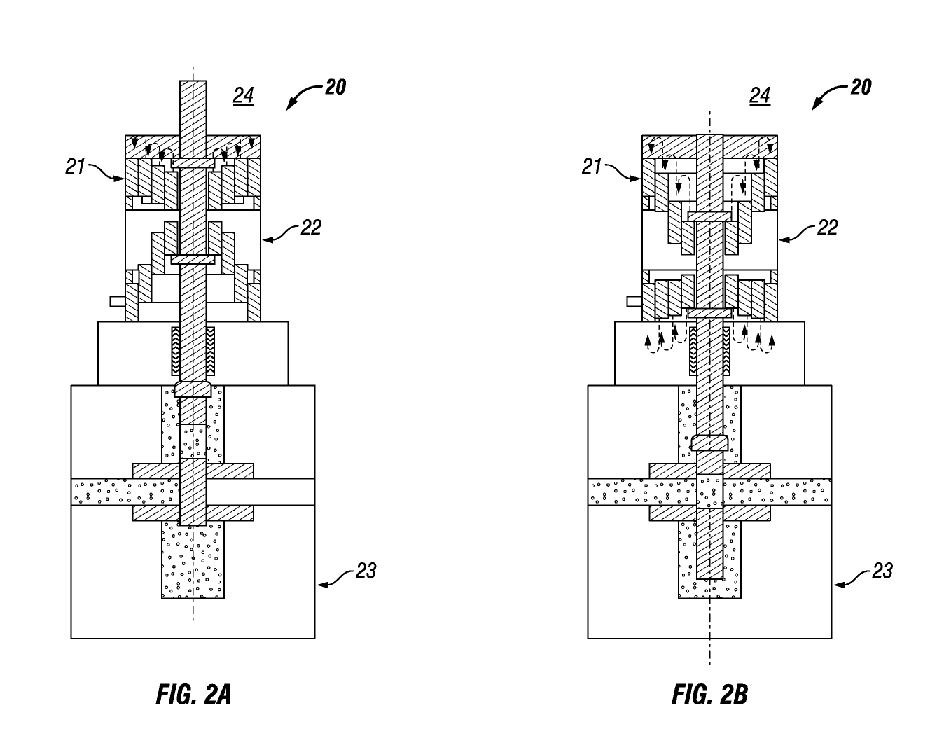

FIG. 2A illustrates an embodiment of a subsea actuator with magnetic return 20 comprising a magnetic motor 22 powered by an electric and a magnetic spring 21. In FIG. 2A, the subsea actuator with magnetic return 20 is in the initial position (magnetic motor off and valve closed). FIG. 2B illustrates an embodiment of a subsea actuator with magnetic return 20 comprising a magnetic motor 22 powered by an electric source and a magnetic spring 21. In FIG. 2B, the subsea actuator with magnetic return 20 is in the stroked position (magnetic motor on and valve open). The subsea actuator with magnetic return 20 can be assembled to a subsea valve 23. The subsea actuator with magnetic return 20 is driven by the magnetic motor 22 to move the valve stem 24 in one linear direction, e.g., to open the subsea valve as shown in FIG. 2B. Once the magnetic motor is turned off, the subsea actuator with magnetic return 20 is moved to the opposite direction via magnetic spring 21. The magnetic spring 21 contains an array of magnets configured to create the required magnetic density and force to move the valve stem 24 back to its initial position. The array of magnets is an arrangement of permanent magnets. The absence of any hydraulic actuator piston in this embodiment reduces the effects from hydrostatic head over the system motion, which in turn requires less spring force resulting in a smaller subsea actuator size.

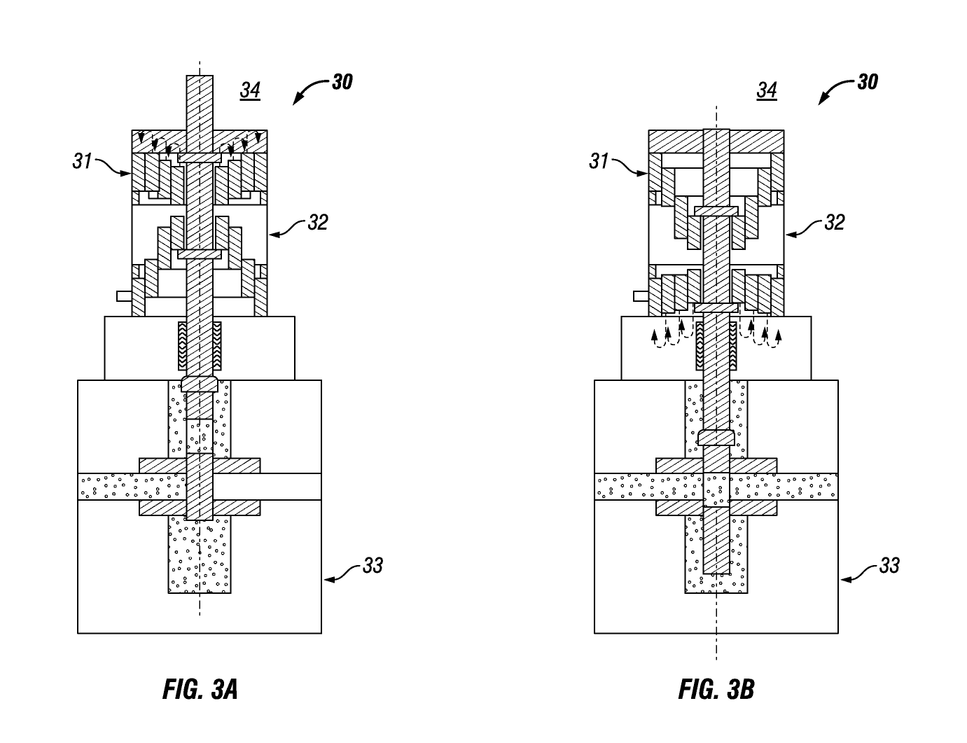

FIG. 3A illustrates an embodiment of a subsea actuator with magnetic return 30 comprising a magnetic motor 32 powered by an electric source and a magnetic spring 31 whose magnetic field can be turned on and off, or shield and unshield the magnetic force. In FIG. 3A, the subsea actuator with magnetic return 30 is in the initial position (magnetic motor off, magnetic spring on, and valve closed). FIG. 3B illustrates an embodiment of a subsea actuator with magnetic return 30 comprising a magnetic motor 32 powered by an electric source and a magnetic spring 31 whose magnetic field can be turned on and off, or shield and unshield the magnetic force. In FIG. 3B, the subsea actuator with magnetic return 30 is in the stroked position (magnetic motor on, magnetic spring off, and valve open). The subsea actuator with magnetic return 30 can be assembled to a subsea valve 33. The magnetic field of the magnetic spring 31 can be turned off when the magnetic motor 32 is turned on to move the stem 34 in one linear direction, e.g., to open the subsea valve as shown in FIG. 3B, so that no resistance from the magnetic spring occurs while the magnetic spring is compressed or extended. The magnetic field of the magnetic spring 31 can be turned on when the magnetic motor 32 is turned off to move the valve stem 34 back to its initial position. In this embodiment, the magnetic spring 31 is located on an actuator assembly where an electric current can turn on and off, or shield and unshield the magnetic field. The ability to turn on and off the magnetic field of the magnetic spring 31 will allow the reduction of the size of the magnetic motor 32. The magnetic spring 31 can also be configured to autonomously return to its initial position via an uninterrupted power supply, e.g., a battery bank.

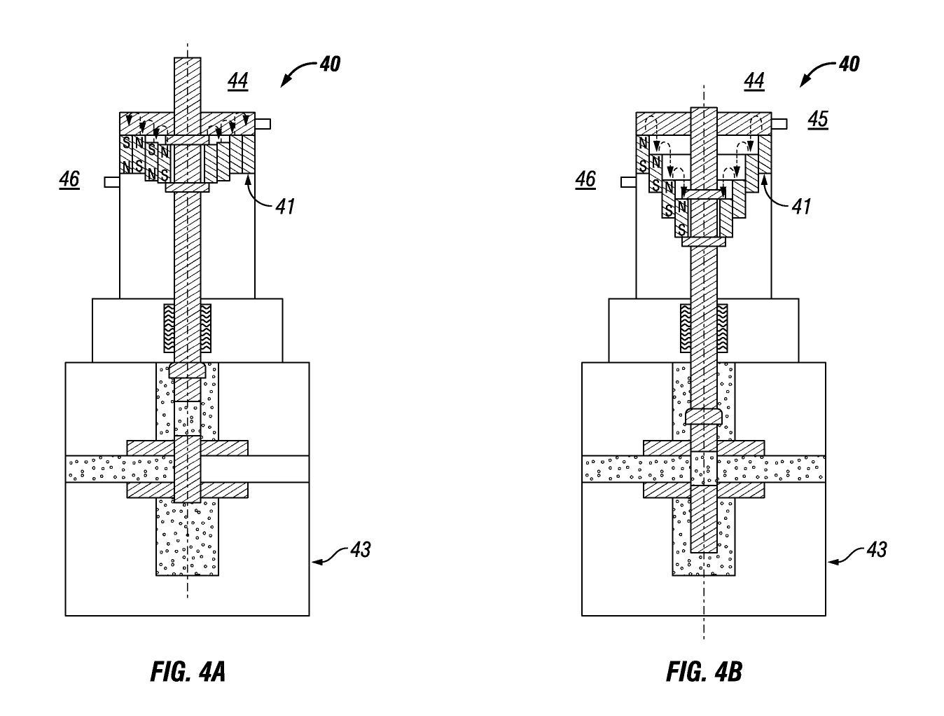

FIG. 4A illustrates an embodiment of a subsea actuator with magnetic return 40 comprising a single magnetic spring 41 powered by an electric source whose variations of current flow direction can make the magnetic spring 41 move to both directions. In FIG. 4A, the subsea actuator with magnetic return 40 is in the initial position (magnetic array of magnetic spring attracting and valve closed). FIG. 4B illustrates an embodiment of a subsea actuator with magnetic return 40 comprising a single magnetic spring 41 powered by an electric source whose variations of current flow direction can make the magnetic spring 41 move to both directions. In FIG. 4B, the subsea actuator with magnetic return 40 is in the stroked position (magnetic array of the magnetic spring is repelling and valve open). The subsea actuator with magnetic return 40 can be assembled to a subsea valve 43. The subsea actuator with magnetic return 40 is driven by the magnetic spring 41 in which electric current applied via the forward power port 45 creates a magnetic field to move the valve stem 44 in a linear stroke, e.g., to open the subsea valve as shown in FIG. 4B. Once the electric current flow is applied to the magnets of the magnetic spring 41 via the reversed power port 46, the magnetic spring 41 creates a magnetic field that moves the valve stem to the opposite side, e.g., to close the subsea valve as shown in FIG. 4A. The adoption of a single bidirectional magnetic spring reduces the complexity of the subsea actuator resulting in a smaller subsea actuator design. The magnetic spring can also be configured to autonomously return to its initial position via an uninterrupted power supply, e.g., a battery bank.

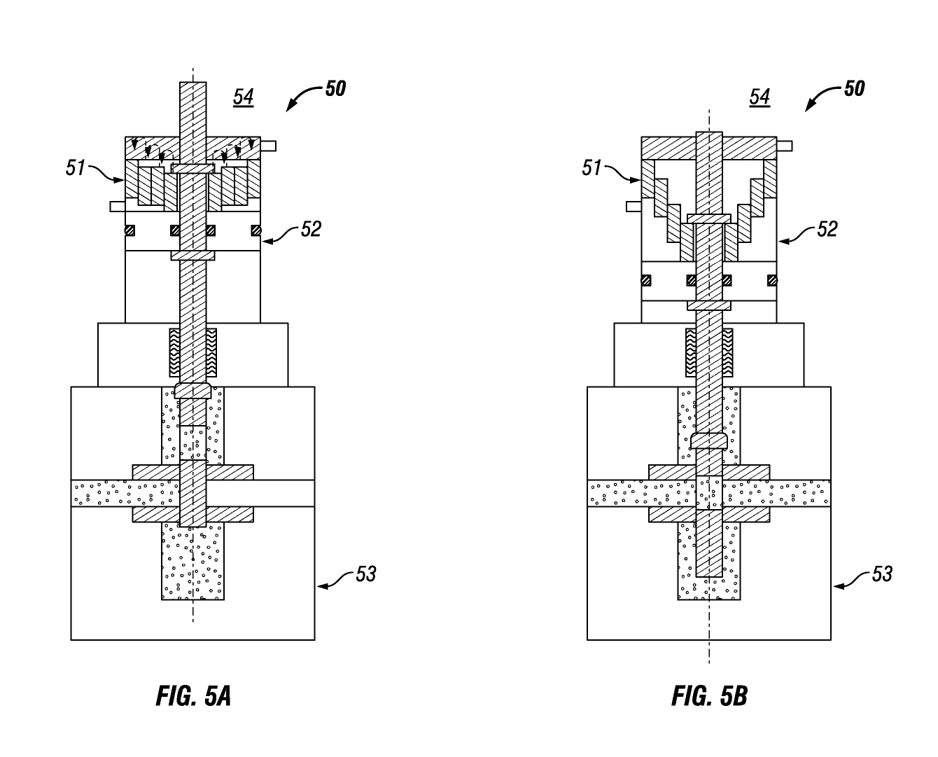

FIG. 5A illustrates an embodiment of a subsea actuator with magnetic return 50 comprising a hydraulic actuator piston 52 and a magnetic spring 51 wherein the magnetic field can be turned on and off. In FIG. 5A, the subsea actuator with magnetic return 50 is in the initial position (magnetic array of magnetic spring on and valve closed). FIG. 5B illustrates an embodiment of a subsea actuator with magnetic return 50 comprising a hydraulic actuator piston 52 and a magnetic spring 51 wherein the magnetic field can be turned on and off. In FIG. 5B, the subsea actuator with magnetic return 50 is in the stroked position (magnetic array of the magnetic spring is off and valve open). The subsea actuator with magnetic return 50 can be assembled to a subsea valve 53. The magnetic field can be turned off when the hydraulic pressure is applied to move the subsea actuator with magnetic return 50 so that no resistance from the magnetic spring 51 occurs when the magnetic spring 51 is compressed or extended. The magnetic field can be turned on when the hydraulic pressure is released to move the valve stem 54 back to its initial position. In this embodiment, the magnetic spring 51 is located on an actuator assembly where an electric current can be turned on and off, or shield and unshield the magnetic field. The ability to turn the magnetic field on and off will allow the hydraulic actuator piston 52 area to be reduced. This reduction in turn will require less spring force to overcome the hydrostatic head resulting in a small actuator size. The magnetic spring can also be configured to autonomously return to its initial position via an uninterrupted power supply, e.g., a battery bank.

In another embodiment, in addition to subsea actuators powered by hydraulic force, a subsea actuator with magnetic return can also be applied to an actuator that operates a valve via other means including, but not limited to, pneumatic pressure, electrical power, or magnetic force. In addition, a subsea actuator can be used in conjunction with a mechanical spring to increase the force of motion of the magnetic spring.

In other embodiments, in addition to a subsea valve, a subsea actuator with magnetic return can also be applied to other types of valves that are operated via linear or rotary motion including but not limited to, a ball valve, a needle valve, or a flap valve. In addition, all the embodiments described herein are applicable for chokes, flow control valves, recirculation valves and equipment alike.

While the methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A subsea actuator with magnetic return comprising:
a) a subsea actuator;
b) a hydraulic piston; and
c) a magnetic spring containing an array of permanent magnets.

2. The subsea actuator with magnetic return of claim 1 wherein the subsea actuator with magnetic return is assembled to a subsea valve.

3. The subsea actuator with magnetic return of claim 2 wherein the magnetic spring containing an array of magnets is configured to create the required magnetic density and force to move a stem of the subsea valve back to an initial position.

4. The subsea actuator with magnetic return of claim 1 wherein a magnetic field of the magnetic spring can be turned on and off.

5. The subsea actuator with magnetic return of claim 4 wherein the subsea actuator with magnetic return is assembled to a subsea valve.

6. The subsea actuator with magnetic return of claim 1 wherein the subsea actuator with magnetic return is assembled to a ball valve.

7. The subsea actuator with magnetic return of claim 1 wherein the subsea actuator with magnetic return is assembled to a needle valve.

8. The subsea actuator with magnetic return of claim 1 wherein the subsea actuator with magnetic return is assembled to a flap valve.

9. The subsea actuator with magnetic return of claim 1 wherein the subsea actuator with magnetic return is assembled to a choke.

10. The subsea actuator with magnetic return of claim 1 wherein the subsea actuator with magnetic return is assembled to a flow control valve.

11. The subsea actuator with magnetic return of claim 1 wherein the subsea actuator with magnetic return is assembled to a recirculation valve.

12. A subsea actuator with magnetic return comprising:
a) a subsea actuator;
b) a magnetic motor powered by an electric source; and
c) a magnetic spring containing an array of permanent magnets.

13. The subsea actuator with magnetic return of claim 12 wherein the subsea actuator with magnetic return is assembled to a subsea valve.

14. The subsea actuator with magnetic return of claim 13 wherein the magnetic spring containing an array of magnets is configured to create the required magnetic density and force to move a stem of the subsea valve back to an initial position.

15. A subsea actuator with magnetic return of claim 12 wherein the magnetic spring is located on an actuator assembly where an electric current can be turned on and off.

16. The subsea actuator with magnetic return of claim 15 wherein the subsea actuator with magnetic return is assembled to a subsea valve.

17. A subsea actuator with magnetic return comprising:
a) a subsea actuator; and
b) a single magnetic spring powered by an electric source wherein variations of current flow direction can make the single magnetic spring move in both directions.

18. The subsea actuator with magnetic return of claim 17 further comprising an uninterrupted power supply.

19. The subsea actuator with magnetic return of claim 17 wherein the subsea actuator with magnetic return is assembled to a subsea valve.

20. A subsea actuator with magnetic return of claim 12 further comprising a mechanical spring to increase the force of motion of the magnetic spring.
